(19) United States
(12) Patent Application Publication
(10) Pub. No.: US 2021/0259502 A1
(43) Pub. Date: Aug. 26, 2021

(54) Curved Sponge and Method of Manufacture

(71) Applicant: Camille Walker, New York, NY (US)

(72) Inventor: Camille Walker, New York, NY (US)

(21) Appl. No.: 17/249,151

(22) Filed: Feb. 22, 2021

Related U.S. Application Data
(60) Provisional application No. 62/978,825, filed on Feb. 20, 2020.

(51) Int. Cl. A47L 13/16; B31F 1/07

(52) U.S. Cl. CPC A47L 13/16; B31F 1/07

(57) ABSTRACT

A sponge assembly with convenience features. The sponge assembly comprises at least a sponge body. The sponge body comprises a top side, a bottom side, two sides, and two ends. The sponge body further comprises a body height, a body thickness, a body length and a body width. The two sides comprise a first side and a second side. The two ends comprise a first end and a second end. The sponge assembly further comprises a logo in the top side of the sponge body. The logo comprises an embossed logo comprises an embossed height. The embossed height comprises a distance between a top surface of the top side of the sponge body and a logo surface.

### CROSS-REFERENCE TO RELATED APPLICATIONS

This application claims benefit to U.S. patent application No. 62/978,825 filed on 2020 Feb. 2020.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

No prior art is known to the Applicant

### BRIEF SUMMARY OF THE INVENTION

A sponge assembly with convenience features. Said sponge assembly comprises at least a sponge body. Said sponge body comprises a top side, a bottom side, two sides, and two ends. Said sponge body further comprises a body height, a body thickness, a body length and a body width. Said two sides comprise a first side and a second side. Said two ends comprise a first end and a second end. Said sponge assembly further comprises a logo in said top side of said sponge body. Said logo comprises an embossed logo comprises an embossed height. Said embossed height comprises a distance between a top surface of said top side of said sponge body and a logo surface. with use, portions of said logo are configured to wear so as to remove or degrade portions of said logo into a worn embossed logo as an indication of an extent of use. Said logo surface is higher than said top side and therefore extends up from said sponge body. Said sponge body comprises a curved shape being convex on said top side. Said sponge body comprises a curved body height. Said curved body height comprises a distance to which said top side and/or said bottom side rise up as compared between a point at said two ends and a center axis of said sponge body. Said sponge body is configured to have a curved shape rising from said first end to said center axis and falling back down at said second end. Said sponge assembly is manufactured by molding said sponge body including said logo.

Said sponge assembly with convenience features. Said sponge assembly comprises at least said sponge body. Said sponge body comprises said top side, said bottom side, said two sides, and said two ends. Said sponge body further comprises said body height, said body thickness, said body length and said body width. Said two sides comprise said first side and said second side. Said two ends comprise said first end and said second end. Said sponge assembly further comprises said logo in said top side of said sponge body. Said logo comprises said embossed logo comprises said embossed height. Said embossed height comprises a distance between said top surface of said top side of said sponge body and said logo surface. with use, portions of said logo are configured to wear so as to remove or degrade portions of said logo into said worn embossed logo as an indication of an extent of use. Said logo surface is higher than said top side and therefore extends up from said sponge body.

Said sponge assembly with convenience features. Said sponge assembly comprises at least said sponge body. Said sponge body comprises said top side, said bottom side, said two sides, and said two ends. Said sponge body further comprises said body height, said body thickness, said body length and said body width. Said two sides comprise said first side and said second side. Said two ends comprise said first end and said second end. Said sponge assembly further comprises said logo in said top side of said sponge body. with use, portions of said logo are configured to wear so as to remove or degrade portions of said logo as an indication of an extent of use. Said logo comprises a debossed logo. Said debossed logo is etched into said top side of said sponge body to an debossed depth. Said debossed depth comprises a distance between said top surface and said logo surface where said logo surface is below said top surface.

### BRIEF DESCRIPTION OF THE SEVERAL VIEWS OF THE DRAWING

FIGS. 1A and 1B illustrate a perspective overview of a sponge assembly 100 of a sponge body 102.

FIGS. 2A, and 2B illustrate a perspective lower view of said sponge body 102.

FIGS. 3A and 3B illustrate an elevated side and top view of said sponge body 102.

FIG. 4 illustrates a perspective overview of said sponge body 102 with a logo 400 being a non-embossed logo 402.

FIG. 5 illustrates a perspective overview of said sponge body 102 with said logo 400 being an embossed logo 500.

FIG. 6 illustrates an elevated side view of said sponge body 102 with said embossed logo 500.

FIG. 7 illustrates a perspective overview of a debossed logo 700 in said sponge body 102.

FIG. 8 illustrates a perspective overview of said sponge body 102 with said debossed logo 700 in cross-section with a detailed view called out.

FIGS. 9A, and 9B illustrate a perspective overview of said sponge assembly 100 with a worn debossed logo 900, and a worn embossed logo 902, respectively.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

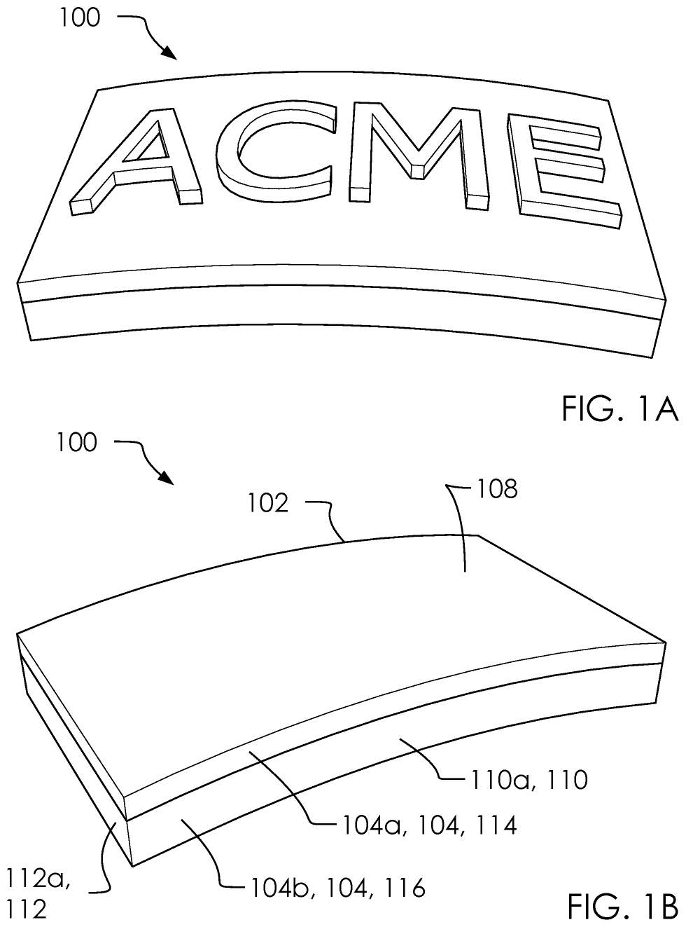

FIGS. 1A and 1B illustrate a perspective overview of a sponge assembly 100 of a sponge body 102.

In one embodiment, said sponge body 102 can comprise one or more layers 104 (which can comprise an upper layer 104a and a lower layer 104b), a top side 108, two sides 110 (which can comprise a first side 110a, and a second side 110b), and two ends 112 (which can comprise a first end 112a, and a second end 112b).

In one embodiment, said upper layer 104a can comprise an abrasive portion 114, and said lower layer 104b can comprise a non-abrasive portion 116 of said sponge body 102. As is known in the art, said lower layer 104b can be more absorbent portion than said upper layer 104a.

In one embodiment, said upper layer 104a and said lower layer 104b can be attached to one another by adhesives, plastic welding, melting, or similar, as is known in the art.

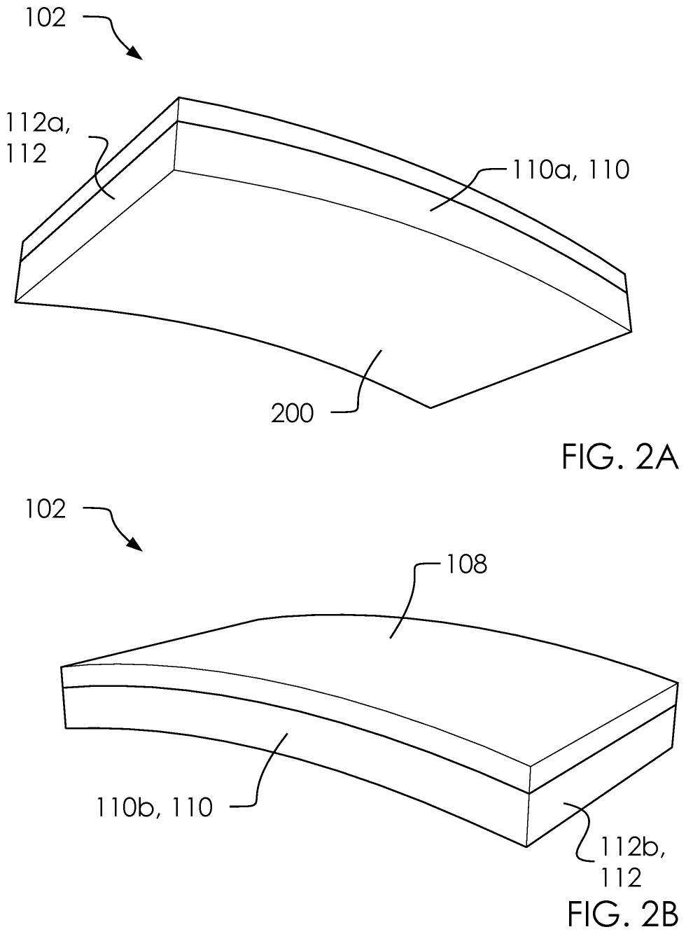

FIGS. 2A, and 2B illustrate a perspective lower view of said sponge body 102.

Said sponge body 102 can comprise a bottom side 200.

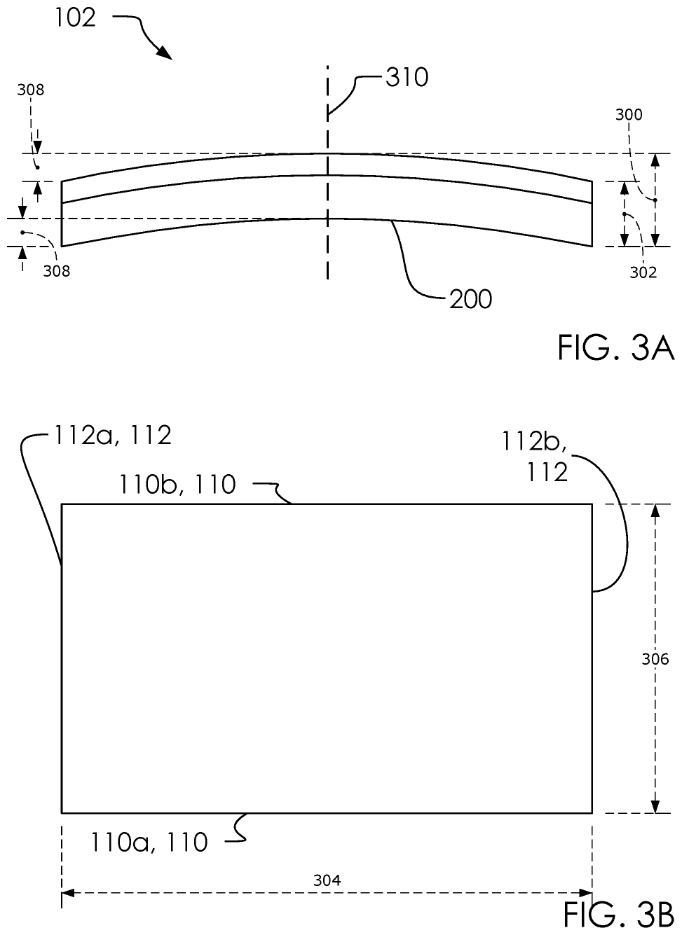

FIGS. 3A and 3B illustrate an elevated side and top view of said sponge body 102.

In one embodiment, said sponge body 102 can comprise a body height 300, a body thickness 302, a body length 304, a body width 306, and a curved body height 308.

In one embodiment, said sponge body 102 can comprise a curved shape being convex on said top side 108 and concave on said bottom side 200.

In one embodiment, said body width 306 can comprise 70 mm, said body length 304 can comprise 120 mm.

In one embodiment, said curved body height 308 can comprise a distance to which said top side 108 and/or said bottom side 200 rise up as compared between a point at said two ends 112 and a center axis 310 of said sponge body 102. Accordingly, said sponge body 102 can have a curved shape rising from said first end 112a to said center axis 310 and falling back down at said second end 112b.

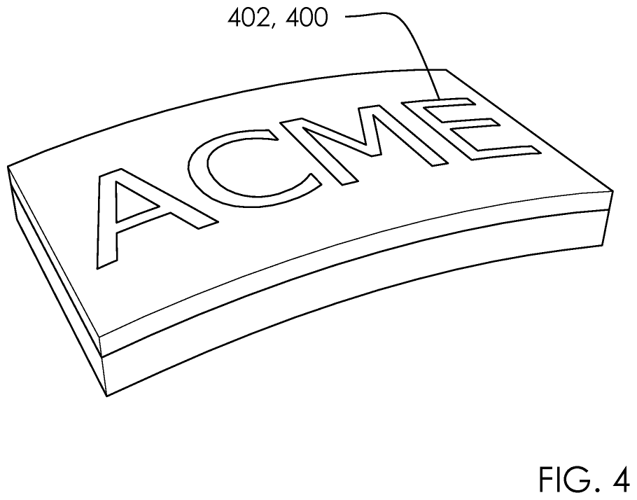

FIG. 4 illustrates a perspective overview of said sponge body 102 with a logo 400 being a non-embossed logo 402.

In one embodiment, said sponge assembly 100 can comprise said sponge body 102 comprising said non-embossed logo 402. Wherein, said sponge assembly 100 can be useful merely due to the curved shape of said sponge body 102. However, as described below, further benefits have been contributed to the nature of said logo 400.

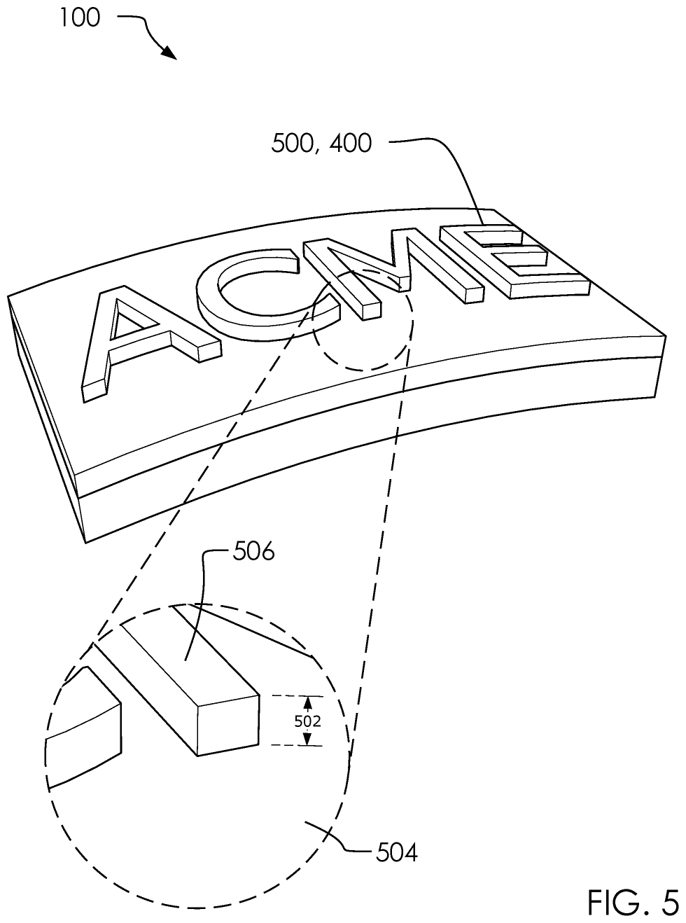

FIG. 5 illustrates a perspective overview of said sponge body 102 with said logo 400 being an embossed logo 500.

In one embodiment, said logo 400 (either as said non-embossed logo 402 or said embossed logo 500) can comprise a laser etched name, symbol or similar according to marketing or other useful indicators.

In one embodiment, said embossed logo 500 can comprise an embossed height 502. Wherein, said embossed height 502 comprises a distance between a top surface 504 of said top side 108 of said sponge body 102 and a logo surface 506. In one embodiment, said sponge assembly 100 can be manufactured by molding said one or more layers 104 with said logo 400 comprising a portion of a mold cavity, as is known in the art. Likewise, said logo 400 can be manufactured by laser etching uppermost layer among said one or more layers 104.

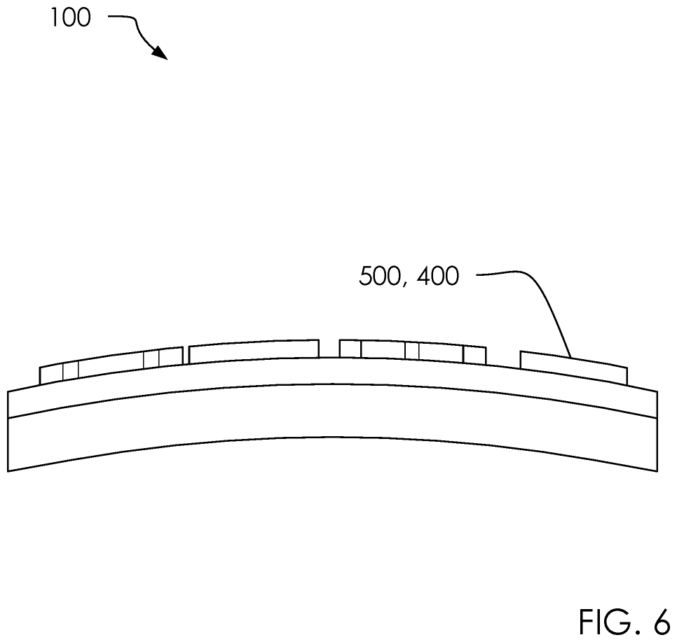

FIG. 6 illustrates an elevated side view of said sponge body 102 with said embossed logo 500.

In one embodiment, said sponge body 102 having a curved shape can allow users to clean in a new and more effective way than with prior sponges. The curved shape of said sponge body 102 can allow a user to access the full range of the abrasive side of the sponge (such as said upper layer 104a) by pressing more of said top side 108 against a target surface, rather than just said two ends 112, as is conventionally applied..

Moreover, said logo 400 can fade with continued use of said sponge body 102 to serve as an indication of the age of said sponge body 102 and thereby remind end users that said sponge body 102 is no longer to be considered to be clean.

In one embodiment, said one or more layers 104 can further comprise a silicon substructure to stiffen and support the given shape of said sponge body 102.

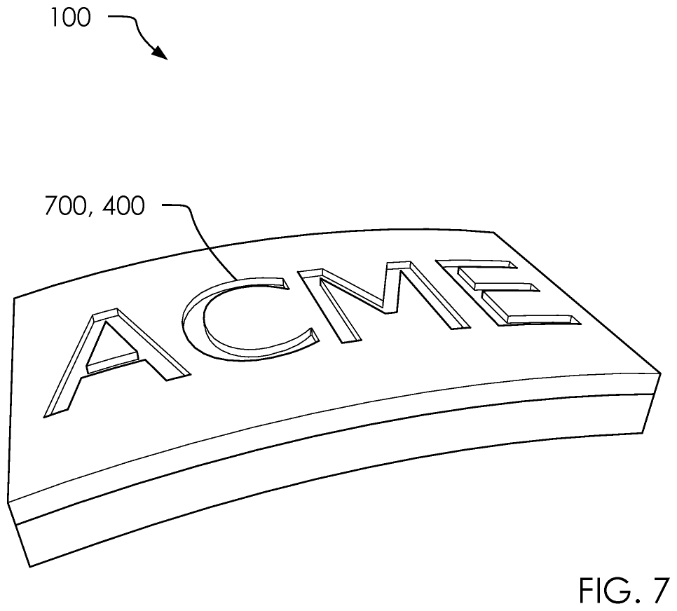

FIG. 7 illustrates a perspective overview of a debossed logo 700 in said sponge body 102.

In one embodiment, said logo 400 can comprise said debossed logo 700. In one embodiment, said debossed logo 700 can be laser etched into said upper layer 104a.

Accordingly, said sponge assembly 100 can comprise said sponge body 102 with said logo 400 selected among said non-embossed logo 402, said embossed logo 500 and said debossed logo 700.

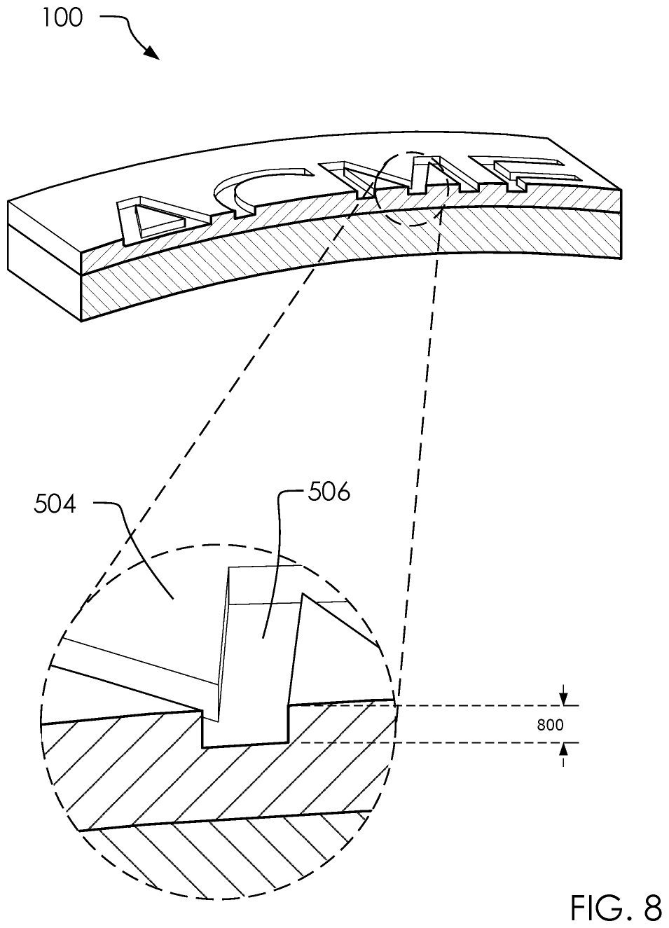

FIG. 8 illustrates a perspective overview of said sponge body 102 with said debossed logo 700 in cross-section with a detailed view called out.

In one embodiment, said debossed logo 700 can be etched into said upper layer 104a to an debossed depth 800. In one embodiment, said debossed depth 800 can comprise 5 mm. In one embodiment, said debossed depth 800 can comprise a distance between said top surface 504 and said logo surface 506 where said logo surface 506 is below said top surface 504.

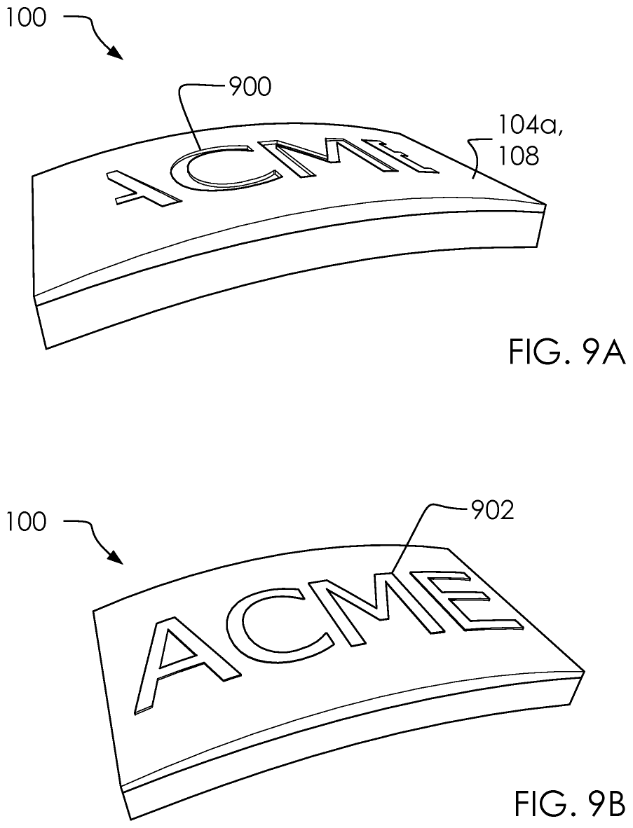

FIGS. 9A, and 9B illustrate a perspective overview of said sponge assembly 100 with a worn debossed logo 900, and a worn embossed logo 902, respectively.

In one embodiment, with use, portions of said upper layer 104a and said logo 400 can wear so as to remove or degrade portions of said debossed logo 700, resulting in said worn debossed logo 900 and/or said worn embossed logo 902.

These sentences are included with reference to the claims:

Said sponge assembly 100 with convenience features. Said sponge assembly 100 comprises at least said sponge body 102. Said sponge body 102 comprises said top side 108, said bottom side 200, said two sides 110, and said two ends 112. Said sponge body 102 further comprises said body height 300, said body thickness 302, said body length 304 and said body width 306. Said two sides 110 comprise said first side 110a and said second side 110b. Said two ends 112 comprise said first end 112a and said second end 112b. Said sponge assembly 100 further comprises said logo 400 in said top side 108 of said sponge body 102. Said logo 400 comprises said embossed logo 500 comprises said embossed height 502. Said embossed height 502 comprises a distance between said top surface 504 of said top side 108 of said sponge body 102 and said logo surface 506. with use, portions of said logo 400 can be configured to wear so as to remove or degrade portions of said logo 400 into said worn embossed logo 902as an indication of an extent of use. Said logo surface 506 can be higher than said top side 108 and therefore extends up from said sponge body 102. Said sponge body 102 comprises a curved shape being convex on said top side 108. Said sponge body 102 comprises said curved body height 308. Said curved body height 308 comprises a distance to which said top side 108 and/or said bottom side 200 rise up as compared between a point at said two ends 112 and said center axis 310 of said sponge body 102. Said sponge body 102 can be configured to have a curved shape rising from said first end 112a to said center axis 310 and falling back down at said second end 112b. Said sponge assembly 100 can be manufactured by molding said sponge body 102 including said logo 400.

Said sponge assembly 100 with convenience features. Said sponge assembly 100 comprises at least said sponge body 102. Said sponge body 102 comprises said top side 108, said bottom side 200, said two sides 110, and said two ends 112. Said sponge body 102 further comprises said body height 300, said body thickness 302, said body length 304 and said body width 306. Said two sides 110 comprise said first side 110a and said second side 110b. Said two ends 112 comprise said first end 112a and said second end 112b. Said sponge assembly 100 further comprises said logo 400 in said top side 108 of said sponge body 102. Said logo 400 comprises said embossed logo 500 comprises said embossed height 502. Said embossed height 502 comprises a distance between said top surface 504 of said top side 108 of said sponge body 102 and said logo surface 506. with use, portions of said logo 400 can be configured to wear so as to remove or degrade portions of said logo 400 into said worn embossed logo 902as an indication of an extent of use. Said logo surface 506 can be higher than said top side 108 and therefore extends up from said sponge body 102.

Said sponge body 102 comprises a curved shape being convex on said top side 108. Said sponge body 102 comprises said curved body height 308. Said curved body height 308 comprises a distance to which said top side 108 and/or said bottom side 200 rise up as compared between a point at said two ends 112 and said center axis 310 of said sponge body 102. Said sponge body 102 can be configured to have a curved shape rising from said first end 112a to said center axis 310 and falling back down at said second end 112b.

Said upper layer 104a and said lower layer 104b can be attached to one another by adhesives, plastic welding, melting, or similar.

Said one or more layers 104 can be configured to further comprise a silicon substructure to stiffen and support the given shape of said sponge body 102.

Said sponge assembly 100 with convenience features. Said sponge assembly 100 comprises at least said sponge body 102. Said sponge body 102 comprises said top side 108, said bottom side 200, said two sides 110, and said two ends 112. Said sponge body 102 further comprises said body height 300, said body thickness 302, said body length 304 and said body width 306. Said two sides 110 comprise said first side 110a and said second side 110b. Said two ends 112 comprise said first end 112a and said second end 112b. Said sponge assembly 100 further comprises said logo 400 in said top side 108 of said sponge body 102. with use, portions of said logo 400 can be configured to wear so as to remove or degrade portions of said logo 400 as an indication of an extent of use. Said logo 400 comprises said debossed logo 700. Said debossed logo 700 can be etched into said top side 108 of said sponge body 102 to said debossed depth 800. Said debossed depth 800 comprises a distance between said top surface 504 and said logo surface 506 where said logo surface 506 can be below said top surface 504.

Said debossed depth 800 comprises 5 mm.

Said sponge body 102 comprises a curved shape being convex on said top side 108. Said sponge body 102 comprises said curved body height 308. Said curved body height 308 comprises a distance to which said top side 108 and/or said bottom side 200 rise up as compared between a point at said two ends 112 and said center axis 310 of said sponge body 102. Said sponge body 102 can be configured to have a curved shape rising from said first end 112a to said center axis 310 and falling back down at said second end 112b.

Said sponge body 102 comprises a curved shape being concave on said bottom side 200.

Said sponge assembly 100 can be manufactured by molding said one or more layers 104 with said logo 400 comprising a portion of a mold cavity.

Said logo 400 can be manufactured by laser etching said top side 108 of said sponge body 102.

Said top side 108 comprises said abrasive portion 114 being more abrasive than said bottom side 200 of said sponge body 102. Said bottom side 200 can be the more absorbent portion than said top side 108.

Said sponge assembly 100 comprises said sponge body 102 with said logo 400 selected among said non-embossed logo 402, said embossed logo 500 and said debossed logo 700.

Said body width 306 comprises 70 mm, said body length 304 comprises 120 mm.

Said logo 400 comprises a name, symbol or similar according to marketing or other useful indicators.

Said sponge body 102 comprises said one or more layers 104. Said one or more layers 104 comprises said upper layer 104a and said lower layer 104b. Said upper layer 104a and said lower layer 104b can be attached to one another by adhesives, plastic welding, melting, or similar.

Said sponge body 102 comprises said one or more layers 104. Said one or more layers 104 comprises said upper layer 104a and said lower layer 104b. Said one or more layers 104 can be configured to further comprise a silicon substructure to stiffen and support the given shape of said sponge body 102.

These parts are introduced in the specification and summarized here for the ease of the reader:

said sponge assembly 100,
said sponge body 102,
said one or more layers 104,
said upper layer 104a,
said lower layer 104b,
said top side 108,
said two sides 110,
said first side 110a,
said second side 110b,
said two ends 112,
said first end 112a,
said second end 112b,
said abrasive portion 114,
said non-abrasive portion 116,
said bottom side 200,
said body height 300,
said body thickness 302,
said body length 304,
said body width 306,
said curved body height 308,
said center axis 310,
said logo 400,
said non-embossed logo 402,
said embossed logo 500,
said embossed height 502,
said top surface 504,
said logo surface 506,
said debossed logo 700,
said debossed depth 800,
said worn debossed logo 900, and
said worn embossed logo 902.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A sponge assembly with convenience features, wherein:
said sponge assembly comprises at least a sponge body;
said sponge body comprises a top side, a bottom side, two sides, and two ends;
said sponge body further comprises a body height, a body thickness, a body length and a body width;
said two sides comprise a first side and a second side;
said two ends comprise a first end and a second end;
said sponge assembly further comprises a logo in said top side of said sponge body;
said logo comprises an embossed logo comprises an embossed height;
said embossed height comprises a distance between a top surface of said top side of said sponge body and a logo surface;
with use, portions of said logo are configured to wear so as to remove or degrade portions of said logo into a worn embossed logo as an indication of an extent of use;
said logo surface is higher than said top side and therefore extends up from said sponge body;
said sponge body comprises a curved shape being convex on said top side;
said sponge body comprises a curved body height;
said curved body height comprises a distance to which said top side and/or said bottom side rise up as compared between a point at said two ends and a center axis of said sponge body;
said sponge body is configured to have a curved shape rising from said first end to said center axis and falling back down at said second end; and
said sponge assembly is manufactured by molding said sponge body including said logo.

2. A sponge assembly with convenience features, wherein:
said sponge assembly comprises at least a sponge body;
said sponge body comprises a top side, a bottom side, two sides, and two ends;
said sponge body further comprises a body height, a body thickness, a body length and a body width;
said two sides comprise a first side and a second side;
said two ends comprise a first end and a second end;
said sponge assembly further comprises a logo in said top side of said sponge body;
said logo comprises an embossed logo comprises an embossed height;
said embossed height comprises a distance between a top surface of said top side of said sponge body and a logo surface;
with use, portions of said logo are configured to wear so as to remove or degrade portions of said logo into a worn embossed logo as an indication of an extent of use; and
said logo surface is higher than said top side and therefore extends up from said sponge body.

3. The sponge assembly of claim 2, wherein:
said sponge body comprises a curved shape being convex on said top side;
said sponge body comprises a curved body height;
said curved body height comprises a distance to which said top side and/or said bottom side rise up as compared between a point at said two ends and a center axis of said sponge body; and
said sponge body is configured to have a curved shape rising from said first end to said center axis and falling back down at said second end.

4. The sponge assembly of claim 2, wherein:
said sponge assembly is manufactured by molding said sponge body including said logo.

5. The sponge assembly of claim 2, wherein:
said logo is manufactured by laser etching said top side of said sponge body.

6. The sponge assembly of claim 2, wherein:
said sponge body comprises one or more layers; and
said one or more layers comprises an upper layer and a lower layer.

7. The sponge assembly of claim 6, wherein:
said upper layer and said lower layer are attached to one another by adhesives, plastic welding, melting, or similar.

8. The sponge assembly of claim 6, wherein:
said one or more layers are configured to further comprise a silicon substructure to stiffen and support the given shape of said sponge body.

9. A sponge assembly with convenience features, wherein:
said sponge assembly comprises at least a sponge body;
said sponge body comprises a top side, a bottom side, two sides, and two ends;
said sponge body further comprises a body height, a body thickness, a body length and a body width;
said two sides comprise a first side and a second side;
said two ends comprise a first end and a second end;
said sponge assembly further comprises a logo in said top side of said sponge body;
with use, portions of said logo are configured to wear so as to remove or degrade portions of said logo as an indication of an extent of use;
said logo comprises a debossed logo;
said debossed logo is etched into said top side of said sponge body to an debossed depth; and
said debossed depth comprises a distance between a top surface and a logo surface where said logo surface is below said top surface.

10. The sponge assembly of claim 9, wherein:
said debossed depth comprises 5 mm.

11. The sponge assembly of claim 9, wherein:
said sponge body comprises a curved shape being convex on said top side;
said sponge body comprises a curved body height;
said curved body height comprises a distance to which said top side and/or said bottom side rise up as compared between a point at said two ends and a center axis of said sponge body; and
said sponge body is configured to have a curved shape rising from said first end to said center axis and falling back down at said second end.

12. The sponge assembly of claim 9, wherein:
said sponge body comprises a curved shape being concave on said bottom side.

13. The sponge assembly of claim 9, wherein:
said sponge assembly is manufactured by molding said sponge body including said logo.

14. The sponge assembly of claim 9, wherein:
said logo is manufactured by laser etching said top side of said sponge body.

15. The sponge assembly of claim 9, wherein:
said top side comprises an abrasive portion being more abrasive than said bottom side of said sponge body; and
said bottom side is the more absorbent portion than said top side.

16. The sponge body of claim 9, wherein:
said sponge assembly comprises said sponge body with said logo selected among a non-embossed logo, an embossed logo and said debossed logo.

17. The sponge assembly of claim 9, wherein:
said body width comprises 70 mm, said body length comprises 120 mm.

18. The sponge assembly of claim 9, wherein:
said logo comprises a name, symbol or similar according to marketing or other useful indicators.

19. The sponge assembly of claim 9, wherein:
said sponge body comprises one or more layers;
said one or more layers comprises an upper layer and a lower layer; and
said upper layer and said lower layer are attached to one another by adhesives, plastic welding, melting, or similar.

20. The sponge assembly of claim 9, wherein:
said sponge body comprises said one or more layers;
said one or more layers comprises said upper layer and said lower layer; and
said one or more layers are configured to further comprise a silicon substructure to stiffen and support the given shape of said sponge body.
